(19) United States
(12) Patent Application Publication
(10) Pub. No.: US 2024/0308679 A1
(43) Pub. Date: Sep. 19, 2024

(54) UNION NUT, PIPE ASSEMBLY, AND VEHICLE

(71) Applicant: Airbus Operations GmbH, Hamburg (DE)

(72) Inventor: Hannes ROHARDT, Hamburg (DE)

(21) Appl. No.: 18/601,139

(22) Filed: Mar. 11, 2024

(30) Foreign Application Priority Data
Mar. 17, 2023 (EP) 23162648.2

(51) Int. Cl. B64D 37/00; B64D 37/30; F16L 19/02

(52) U.S. Cl. CPC B64D 37/005; B64D 37/30; F16L 19/0212

(57) ABSTRACT

A union nut with an annular body portion comprising an interior thread, and a collar portion projecting toward an axis of the annular body portion and including threaded holes. A pipe assembly and a vehicle are disclosed.

### TECHNICAL FIELD

The disclosure herein is directed to a union nut, a pipe assembly, and a vehicle.

### BACKGROUND

Pipes of various kinds are used to transport all sorts of materials in liquid or gaseous form. At connection points between separate pipes, a tight sealing has to be provided in order to prevent leakage of the transported material. In order to provide a sufficiently tight sealing, various methods of connecting pipes are used, for example union nuts and clamping nuts.

Recently, hydrogen has become a desired fuel for various vehicles, in particular for aircrafts. Due to the molecular properties of hydrogen, the sealing of hydrogen supply systems has to be especially tight, which exacerbates the various challenges of designing such a system.

For instance, in order to provide union nuts, which are in themselves comparatively small and light-weight, with the torque necessary to create the appropriate sealing force, special equipment has to be used which often requires comparatively much space, which can make mounting union nuts in the confined spaces of an aircraft challenging. On the other hand, clamping nuts, which require less specialized mounting equipment, as they distribute the necessary load over a plurality of bolts, are in themselves comparatively large and heavy-weight, both of which are characteristics which are not desired in aircraft construction.

### SUMMARY

In view of the above, it is an objective of the disclosure herein to provide a tight sealing for pipe assemblies with as low weight and small dimensions as possible.

This objective is achieved with a union nut, a pipe assembly, and a vehicle with features disclosed herein.

According to a first aspect of the disclosure herein, a union nut with an annular body portion comprising an interior thread, and a collar portion projecting toward an axis of the annular body portion and comprising a plurality of threaded holes, is provided.

According to a second aspect of the disclosure herein, a pipe assembly comprising a first pipe comprising a first flange portion comprising an exterior thread, a second pipe comprising a second flange portion, which abuts against the first flange portion of the first pipe to create a sealing area, a union nut according to the disclosure herein, wherein the union nut is arranged such that the interior thread of the union nut interlocks with the exterior thread of the first pipe and that the collar portion of the union nut abuts the second flange portion of the second pipe, and a plurality of screws, wherein each of the plurality of screws is screwed through one of the plurality of threaded holes of the union nut such that each of the plurality of screws applies force directly to the second flange portion of the second pipe, is provided.

According to a third aspect of the disclosure herein, a vehicle, in particular an aircraft, comprising a pipe assembly according to the disclosure herein, is provided.

One of the ideas of the disclosure herein is to provide a union nut with an additional clamping function, i.e. to use the union nut as a leverage point for additional screws to apply additional force to a flange portion of a pipe, thereby further tightening the sealing created by the abutting flange portions of the assembled pipes. In this way, the advantages of a union nut design, e.g. the compactness of the design, with the advantages of a clamping nut design, e.g. the additive combination of multiple actors, each of which only provides a comparatively small force.

According to a preferred embodiment of the union nut, the plurality of threaded holes are arranged axially symmetric on the collar portion. In this way, the screws can apply their respective forces in an advantageous even manner.

According to a further embodiment of the union nut, the annular body portion comprises a plurality of notches arranged around an outer circumference of the annular body portion. These notches can provide advantageous points of leverage when mounting the union nut.

According to a preferred embodiment of the pipe assembly, at least one of the first pipe and the second pipe are configured as thin-walled pipes. This is made possible by the fact that there are no torsional forces applied to the pipes, contrary to regular union nuts. In this way, the pipes have an advantageously small weight.

According to a further embodiment of the pipe assembly, at least one of the first pipe and the second pipe comprises wall thickness of less than 1 mm. In this way, the pipes have an advantageously small weight.

According to a further embodiment of the pipe, at least one of the first pipe and the second pipe comprises stainless steel, aluminum, or metal-coated carbon. These materials have advantageous characteristics for various use cases, in particular for pipes conducting hydrogen.

According to a further embodiment of the pipe assembly, the union nut comprises aluminum, titanium or a fiber-reinforced composite. These materials have advantageous characteristics, in particular concerning their weight.

According to a further embodiment of the pipe assembly, the plurality of screws comprises button head screws, socket head screws, or headless screws. These screw types have advantageous characteristics for various use cases.

According to a further embodiment, the pipe assembly further comprises a sealing washer arranged between the first flange portion of the first pipe and the second flange portion of the second pipe. The sealing washer advantageously further reinforces the sealing area.

According to a preferred embodiment of the vehicle, the pipe assembly is part of a supply system. This is a particularly preferred use case, in particular in aircrafts.

According to a further embodiment of the vehicle, the supply system is a hydrogen supply system. This is a particularly preferred use case, in particular in aircrafts.

### BRIEF DESCRIPTION OF THE DRAWINGS

The disclosure herein is explained in more detail below with reference to the embodiments shown in the schematic figures.

FIG. 1a is a schematic side-cut view of the union nut according to an embodiment of the disclosure herein;

FIG. 1b is a schematic front view of a union nut shown in FIG. 1a;

FIG. 2 is a schematic side-cut view of a pipe assembly according to an embodiment of the disclosure herein; and

FIG. 3 is a schematic illustration of an aircraft according to an embodiment of the disclosure herein.

In the figures of the drawing, elements, features and components which are identical, functionally identical and of identical action are denoted in each case by the same reference designations unless stated otherwise.

### DETAILED DESCRIPTION

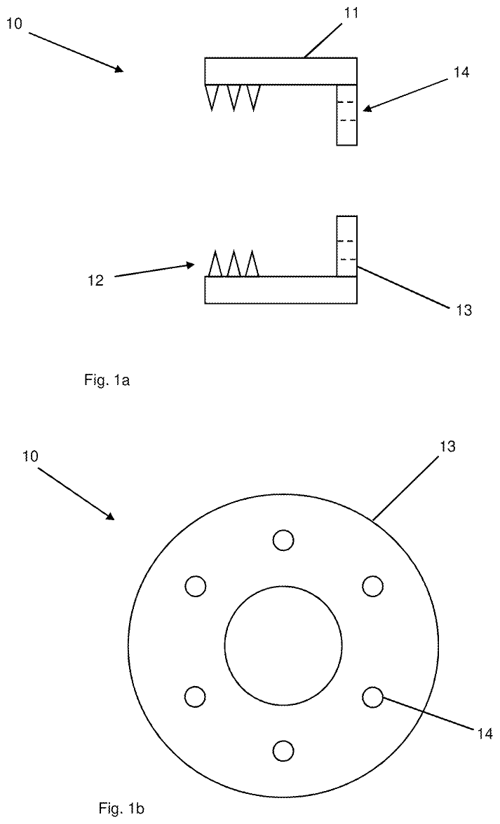

FIGS. 1a and 1b show a schematic side-cut view and a schematic front view of a union nut 10 according to an embodiment of the disclosure herein.

The union nut 10 comprises an annular body portion 11 comprising an interior thread 12, and a collar portion 13 projecting toward an axis of the annular body portion 11 and comprising a plurality of threaded holes 14. The threads of the threaded holes 14 are not shown for reasons of clarity

In the embodiment shown in FIGS. 1a and 1b, the union nut comprises six threaded holes 14 which are arranged axially symmetric on the collar portion 13. Other numbers and arrangements of threaded holes 14 are also possible.

In the embodiment shown in FIGS. 1a and 1b, the annular body portion 11 is entirely circular. This embodiment has the advantage of not having any sharp edges which might pose a risk of damaging adjacent parts. Alternatively, the annular body portion 11 may comprise a plurality of notches arranged around an outer circumference of the annular body portion 11, which can provide points of leverage when mounting the union nut 10 to a pipe.

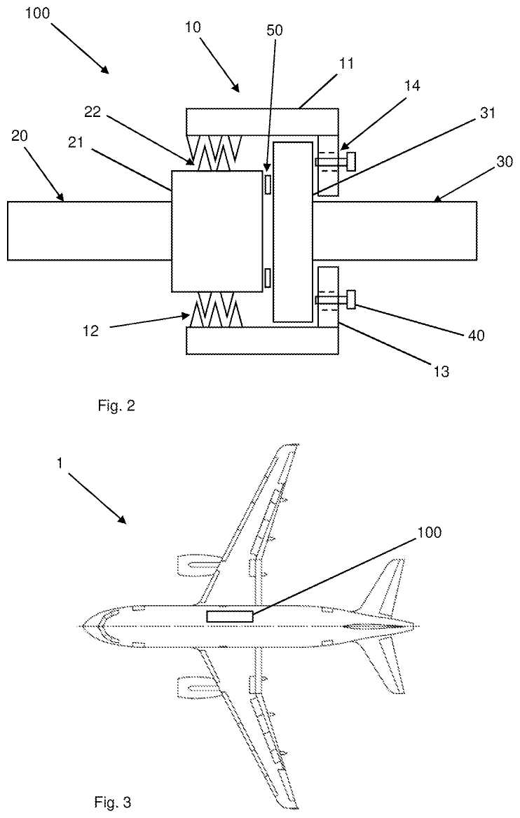

The utility of the union nut 10 will be explained in more detail with reference to FIG. 2.

FIG. 2 shows a schematic side-cut view of a pipe 100 assembly according to an embodiment of the disclosure herein.

The pipe assembly 100 comprises a first pipe 20 comprising a first flange portion 21 comprising an exterior thread 22, a second pipe 30 comprising a second flange portion 31, a union nut 10, a plurality of screws 40, and a sealing washer 50. The union nut 10 is configured in the same way as the embodiment shown in FIGS. 1a and 1b.

In FIG. 2, the various components of the pipe assembly 100 are shown separate and spaced apart from one another. This is done purely for legibility reasons. For a real pipe assembly 100, the various components will be in direct contact with one another.

The second flange portion 31 of the second pipe 30 abuts against the first flange portion 21 of the first pipe 20 to create a sealing area. The union nut 10 is arranged such that the interior thread 12 of the union nut 10 interlocks with the exterior thread 22 of the first flange portion 21 of the first pipe 20 and that the collar portion 13 of the union nut 10 abuts the second flange portion 31 of the second pipe 30. In this way, the union nut 10 presses the second flange portion 31 against the first flange portion 21, reinforcing the sealing area.

Each of the plurality of screws 40 is screwed through one of the plurality of threaded holes 14 of the union nut 10 such that each of the plurality of screws 40 applies force directly to the second flange portion 31 of the second pipe 30. Through the application of this force, the plurality of screws 40 further reinforce the sealing area above what is provided by the union nut 10 on its own.

FIG. 2, being a schematic drawing, gives no information as to the exact proportions and design of the various components. At least one of the first pipe 20 and the second pipe 30 can configured as thin-walled pipes, in particular with a wall thickness of less than 1 mm. Creating tight seals with these kinds of pipes can be challenging, as the various forces acting on the pipes, especially at the sealing area, have to be compensated, which the pipe assembly 100 shown in FIG. 2 accomplishes in a particular advantageous manner.

At least one of the first pipe 20 and the second pipe 30 may comprise stainless steel, aluminum, or metal-coated carbon and the union nut 10 may comprise aluminum, titanium, or a fiber-reinforced composite. These materials can be of particular advantage in various use cases due to their particular characteristics. The plurality of screws 40 comprises button head screws, socket head screws, or headless screws, which can be advantageous depending on the details of the particular embodiment. The type of threading used and the size of the screws can be adapted to the peculiarities of the specific embodiment.

The sealing washer 50, which is purely optional, is arranged between the first flange portion 21 of the first pipe 20 and the second flange portion 31 of the second pipe 30 and further reinforces the sealing area created by the first flange portion and the second flange portion. Additionally to or instead of the sealing washer 50, any type of component, which is capable of reinforcing the sealing area can be used.

FIG. 3 shows a schematic illustration of an aircraft 1 according to an embodiment of the disclosure herein.

The aircraft 1 comprises a pipe assembly 100. This pipe assembly 100, which is not shown in detail in FIG. 3, can be configured in the way shown in FIG. 2. In general, an aircraft 1 will comprise multiple pipe assemblies 100, which form parts of a supply system, in particular a hydrogen supply system.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

11 annular body portion
12 interior thread
13 collar portion
14 threaded hole
20 first pipe
21 first flange portion
22 exterior thread
30 second pipe
31 second flange portion

1. A union nut comprising:
an annular body portion comprising an interior thread; and
a collar portion projecting toward an axis of the annular body portion and comprising a plurality of threaded holes.

2. The union nut according to claim 1, wherein the plurality of threaded holes are arranged axially symmetric on the collar portion.

3. The union nut according to claim 1, wherein the annular body portion comprises a plurality of notches arranged around an outer circumference of the annular body portion.

4. A pipe assembly comprising:
a first pipe comprising a first flange portion comprising an exterior thread;
a second pipe comprising a second flange portion, which abuts against the first flange portion of the first pipe to create a sealing area;
the union nut according to claim 1, wherein the union nut is arranged such that the interior thread of the union nut interlocks with the exterior thread of the first pipe and that the collar portion of the union nut abuts the second flange portion of the second pipe; and
a plurality of screws, wherein each of the plurality of screws is screwed through one of the plurality of threaded holes of the union nut such that each of the plurality of screws applies force directly to the second flange portion of the second pipe.

5. The pipe assembly according to claim 4, wherein at least one of the first pipe and the second pipe are configured as thin-walled pipes.

6. The pipe assembly according to claim 5, wherein at least one of the first pipe and the second pipe comprises wall thickness of less than 1 mm.

7. The pipe assembly according to claim 4, wherein at least one of the first pipe and the second pipe comprises stainless steel, aluminum, or metal-coated carbon.

8. The pipe assembly according to claim 4, wherein the union nut comprises aluminum, titanium, or a fiber-reinforced composite.

9. The pipe assembly according to claim 4, wherein the plurality of screws comprises button head screws, socket head screws, or headless screws.

10. The pipe assembly according to claim 4, comprising a sealing washer arranged between the first flange portion of the first pipe and the second flange portion of the second pipe.

11. A vehicle or aircraft comprising the pipe assembly according to claim 4.

12. The vehicle according to claim 11, wherein the pipe assembly is part of a supply system.

13. The vehicle according to claim 12, wherein the supply system is a hydrogen supply system.
